(19) United States
(12) Patent Application Publication
(10) Pub. No.: US 2008/0165289 A1
(43) Pub. Date: Jul. 10, 2008

(54) RECEIVING APPARATUS

(75) Inventor: Senichi FURUTANI, Osaka (JP)

Correspondence Address: GLOBAL IP COUNSELORS, LLP, 1233 20TH STREET, NW, SUITE 700, WASHINGTON, DC, 20036-2680, US

(73) Assignee: FUNAI ELECTRIC CO., LTD., Osaka (JP)

(21) Appl. No.: 11/965,933

(22) Filed: Dec. 28, 2007

(30) Foreign Application Priority Data
Jan. 4, 2007 (JP) 2007-000089

(51) Int. Cl. H04N 5/44

(52) U.S. Cl. 348/725; 348/E05.096

(57) ABSTRACT

A receiving apparatus for receiving digital signals in a HDMI standard includes a plurality of HDMI input terminals, a designating component and a switching component. The plurality of HDMI input terminals is configured to receive the digital signals in the HDMI standard. The designating component is configured to designate one of the HDMI input terminals as a designated HDMI input terminal. The switching component is configured to switch the HDMI input terminals between a power-on state and a power-off state in response to designating the designated HDMI input terminal.

### CROSS-REFERENCE TO RELATED APPLICATIONS

This application claims priority to Japanese Patent Application No. 2007-000089 filed on Jan. 4, 2007. The entire disclosure of Japanese Patent Application No. 2007-000089 is hereby incorporated herein by reference.

### BACKGROUND OF THE INVENTION

1. Field of the Invention

The present invention generally relates to a receiving apparatus. More specifically, the present invention relates to a receiving apparatus for receiving digital signals.

2. Background Information

DVI (Digital Visual Interface) standard has been known as a standard for transmitting digital video signals. With a transmission system based on the DVI standard, an analog audio signal is sent separately from the digital video signal.

In recent years, HDMI (High-Definition Multimedia Interface) standard has been known as an improved version of the DVI standard. The HDMI standard allows video, audio, and control signals to be sent and received with a single cable. Therefore, connectors and cables are simpler than those of the DVI standard. Furthermore, the manufacturing cost is lower, and management is easier. As a result, the HDMI standard has begun to supplant the DVI standard.

With the HDMI standard, audio transmission can be performed by multiplexing a digital audio signal in the blanking period of a digital video signal. Furthermore, the digital video signal can be sent in a color difference Y, Cb, Cr format in addition to the R, G, B format. Moreover, connections can be made with a USB (Universal Serial Bus)-like compact HDMI connector. With a conventional receiving apparatus, attribute information about an inputted video signal can be transferred from an HDMI controller housed in an HDMI signal processor based on the HDMI standard to allow the conventional receiving apparatus to respond quicker when the conventional receiving apparatus select HDMI input (see Japanese Laid-Open Patent Publication No. 2001-19809, for example). Also, a receiving apparatus capable of accommodating signals in the HDMI standard as well as signals of the DVI standard has been proposed (see Japanese Laid-Open Patent Publication No. 2006-19890, Japanese Laid-Open Patent Publication No. 2006-19947 or Japanese Utility Model Registration No. 3,117,073, for example).

A copy protection function called HDCP (High-bandwidth Digital Content Protection) is provided at HDMI terminals based on the HDMI standard. With the HDCP, after a sending apparatus and a receiving apparatus are connected and authenticate each other, signals are sent and received using an agreed upon code between the sending apparatus and the receiving apparatus. Specifically, the sending apparatus (source device) that sends signals in the HDMI standard and the receiving apparatus (sink device) that receives signals in the HDMI standard execute authentication processing before sending and receiving signals in the HDMI standard.

The source device begins the authentication processing with the sink device only when power is on to the HDMI input terminal provided to the sink device. In other words, the source device begins the authentication processing with the sink device only when a hot plug of the HDMI input terminal is enabled (or in an ON state). Therefore, the sink device always has the HDMI input terminal powered up so that the authentication processing can be executed at any time.

However, when a plurality of HDMI input terminals are provided to a receiving apparatus, the power has to be always on to all of the HDMI input terminals. Thus, electricity is wasted.

In view of the above, it will be apparent to those skilled in the art from this disclosure that there exists a need for an improved receiving apparatus. This invention addresses this need in the art as well as other needs, which will become apparent to those skilled in the art from this disclosure.

### SUMMARY OF THE INVENTION

It is an object of the present invention to provide a receiving apparatus with which power consumption is reduced.

In accordance with first aspect of the present invention, a receiving apparatus for receiving digital signals in a HDMI standard includes a plurality of HDMI input terminals, a designating component and a switching component. The plurality of HDMI input terminals is configured to receive the digital signals in the HDMI standard. The designating component is configured to designate one of the HDMI input terminals as a designated HDMI input terminal. The switching component is configured to switch the HDMI input terminals between a power-on state and a power-off state in response to designating the designated HDMI input terminal.

With the receiving apparatus of the present invention, it is possible to provide a receiving apparatus with which power consumption is reduced.

These and other objects, features, aspects and advantages of the present invention will become apparent to those skilled in the art from the following detailed description, which, taken in conjunction with the annexed drawings, discloses selected embodiments of the present invention.

### BRIEF DESCRIPTION OF THE DRAWINGS

Referring now to the attached drawings which form a part of this original disclosure:

FIG. 1 is a block diagram illustrating a functional configuration of a television receiver in accordance with a first embodiment of the present invention;

FIG. 2 is a flowchart illustrating first processing related to power switching of an HDMI input terminal in the television receiver illustrated in FIG. 1;

FIG. 3 is a flowchart illustrating second processing related to power switching of an HDMI input terminal in the television receiver illustrated in FIG. 1;

FIG. 4 is a block diagram illustrating a functional configuration of a television receiver in accordance with a second embodiment of the present invention;

FIG. 5 is a flowchart illustrating first processing related to power switching of an HDMI input terminal in the television receiver illustrated in FIG. 4; and

FIG. 6 is a flowchart illustrating second processing related to power switching of an HDMI input terminal in the television receiver illustrated in FIG. 4.

### DETAILED DESCRIPTION OF THE PREFERRED EMBODIMENTS

Selected embodiments of the present invention will now be explained with reference to the drawings. It will be apparent to those skilled in the art from these disclosures that the following descriptions of the selected embodiments of the present invention are provided for illustration only and not for the purpose of limiting the invention as defined by the appended claims and their equivalents.

In the selected embodiments, a television receiver will be described as an example of a receiving apparatus (sink device), and a DVD (Digital Versatile Disk) player as an example of a sending apparatus (source device).

### First Embodiment

### Configuration of Television Receiver

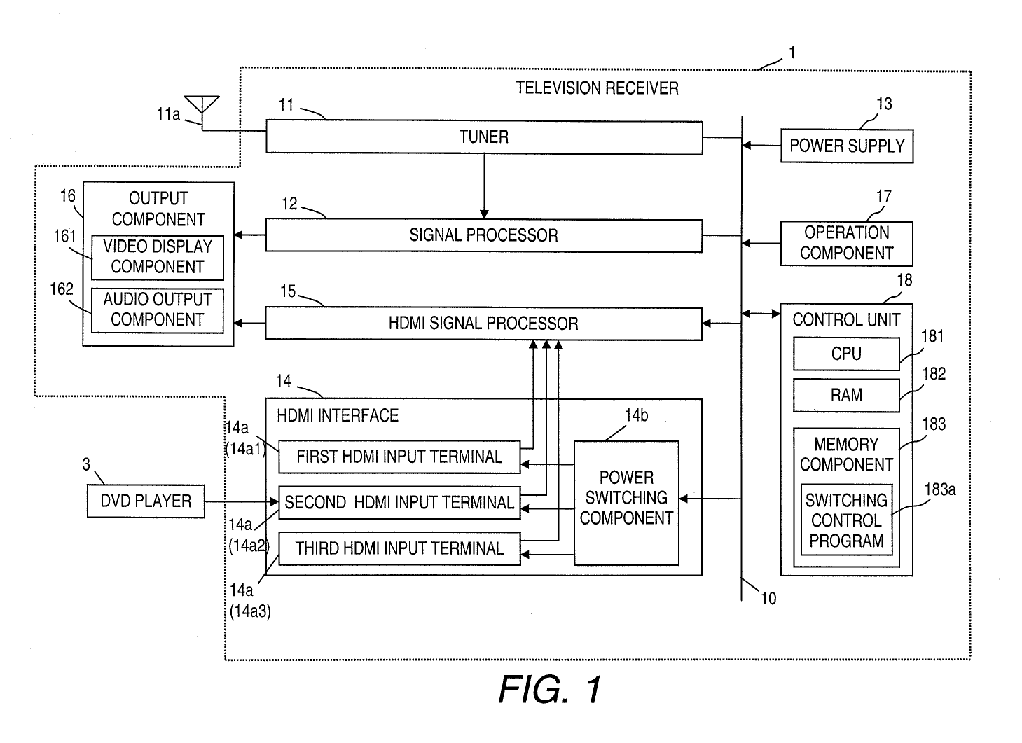

First, a configuration of a television receiver (e.g., receiving apparatus) 1 will be described. As shown in FIG. 1, the television receiver 1 includes a tuner 11 having an antenna 11a, a signal processor 12, a power supply 13, an HDMI interface 14, an HDMI signal processor 15, an output component 16, a operation component 17, a control unit 18, etc. These components are connected by a bus 10.

The television receiver 1 is connected to a DVD player 3. The DVD player 3 sends HDMI digital signals (digital video signals or digital audio signals) in a HDMI (High-Definition Multimedia Interface) standard. The television receiver 1 receives the HDMI digital signals sent by the DVD player 3.

More specifically, the television receiver 1 has a plurality of (such as three) HDMI input terminals 14a. The DVD player 3 has a HDMI output terminal (not shown) based on the HDMI standard. The HDMI output terminal of the DVD player 3 is connected to one of the HDMI input terminals 14a of the television receiver 1.

A copy protection function called HDCP (High-bandwidth Digital Content Protection) is provided at HDMI terminals based on the HDMI standard. Thus, once the television receiver 1 and the DVD player 3 are connected together and have authenticated each other, signals are sent and received using an agreed upon code between the television receiver 1 and the DVD player 3. Specifically, the television receiver 1, which receives the HDMI digital signals, and the DVD player 3, which sends the HDMI digital signals, execute authentication processing before sending and receiving the HDMI digital signals.

The authentication processing is executed only when the power is on at a HDMI input terminal 14a connected to the DVD player 3 out of the plurality of HDMI input terminals 14a provided to the television receiver 1. Specifically, the authentication processing is executed between the television receiver 1 and the DVD player 3 via the HDMI input terminal 14a that is powered. In other words, only when a hot plug of the HDMI input terminal 14a connected to the DVD player 3 is enabled, the authentication processing is executed between the television receiver 1 and the DVD player 3 via the HDMI input terminal 14a that is powered. This is because the HDMI input terminal 14a does not respond to the signal for commencing the authentication processing send from the DVD player 3 if the power is off.

The tuner 11 receives a television broadcast signal via television broadcast waves according to a control signal inputted from the control unit 18. For example, the tuner 11 receives the television broadcast signal related to a program selected by operating the operation component 17. More specifically, for example, the tuner 11 receives a television broadcast signal in a frequency band corresponding to a channel of the program the user wishes to view, from the television broadcast waves received by the antenna 11a (such as digital television broadcast waves). Then, the received television broadcast signal is modulated and outputted to the signal processor 12.

The signal processor 12 subjects the television broadcast signal inputted from the tuner 11 to specific processing according to a control signal inputted from the control unit 18. For example, the signal processor 12 separates the television broadcast signal into video data, audio data, etc. The video data is decoded and outputted to a video display component 161 of the output component 16, while the audio data is decoded and outputted to an audio output component 162 of the output component 16.

The power supply 13 supplies power to the various components of the television receiver 1.

The HDMI interface 14 sends and receives various kinds of information to and from the DVD player 3. More specifically, as shown in FIG. 1, the HDMI interface 14 includes a plurality of HDMI input terminals 14a (such as a first HDMI input terminal 14a1, a second HDMI input terminal 14a2, and a third HDMI input terminal 14a3), and a power switching component 14b, etc.

The HDMI input terminals 14a are terminals for receiving the HDMI digital signals and outputted the HDMI digital signals to the HDMI signal processor 15. For instance, in FIG. 1, the second HDMI input terminal 14a2 is connected to the DVD player 3. Thus, the television receiver 1 executes the authentication processing with the DVD player 3 via the second HDMI input terminal 14a2. Then, the television receiver 1 receives the HDMI digital signal send by the DVD player 3.

In FIG. 1, the second HDMI input terminal 14a2 is connected to the DVD player 3, but instead the first HDMI input terminal 14a1 can be connected to the DVD player 3, or the third HDMI input terminal 14a3 can be connected to the DVD player 3. Also, in FIG. 1, the television receiver 1 is connected to a single DVD player 3, but the television receiver 1 can instead be connected to a plurality of DVD players 3. Specifically, any two of the first HDMI input terminal 14a1, the second HDMI input terminal 14a2, and the third HDMI input terminal 14a3 can be connected to each of the plurality of DVD players 3, or all of the HDMI input terminals 14a (the first HDMI input terminal 14a1, the second HDMI input terminal 14a2, and the third HDMI input terminal 14a3) can be connected to each of the plurality of DVD players 3.

The power switching component 14b switches the plurality of the HDMI input terminals 14a between a power-on state and a power-off state according to a control signal inputted from the control unit 18. The power-on state is a state in which the hot plug is enabled (e.g., switched on). The power-off state is a state in which the hot plug is disabled (e.g., switched off).

More specifically, the power switching component 14b switches the connection on and off between the power supply 13 and the first HDMI input terminal 14a1, and thereby switches the first HDMI input terminal 14a1 between a state in which the hot plug is switched on and a state in which the hot plug is switched off. Also, the power switching component 14b switches the connection on and off between the power supply 13 and the second HDMI input terminal 14a2, and thereby switches the second HDMI input terminal 14a2 between a state in which the hot plug is switched on and a state in which the hot plug is switched off. Also, the power switching component 14b switches the connection on and off between the power supply 13 and the third HDMI input terminal 14a3, and thereby switches the third HDMI input terminal 14a3 between a state in which the hot plug is switched on and a state in which the hot plug is switched off.

The HDMI signal processor 15 subjects the HDMI digital signal inputted from the first HDMI input terminal 14a1, the second HDMI input terminal 14a2, or the third HDMI input terminal 14a3, to specific processing according to a control signal inputted from the control unit 18. For example, the HDMI signal processor 15 separates the HDMI digital signal into video data, audio data, etc. The video data is decoded and outputted to the video display component 161 of the output component 16, while the audio data is decoded and outputted to the audio output component 162 of the output component 16.

The output component 16 is connected to the signal processor 12 and the HDMI signal processor 15. The output component 16 is used for outputting data inputted from the signal processor 12 or the HDMI signal processor 15, for example. More specifically, as shown in FIG. 1, the output component 16 includes the video display component 161, the audio output component 162, etc.

The video display component 161 is a liquid crystal display device, for example. The video display component 161 displays a video image based on the video data inputted from the signal processor 12 or the HDMI signal processor 15.

The audio output component 162 is a speaker device, for example. The audio output component 162 outputs sound based on the audio data inputted from the signal processor 12 or the HDMI signal processor 15.

The operation component 17 includes operation buttons, or a remote control and a remote control receiver. The operation buttons are provided on an outer face of the television receiver 1. The remote control receiver communicates with the remote control for the television receiver 1. For instance, when the user operates the operation component 17, various kinds of signal are outputted to the control unit 18 according to the operation performed.

More specifically, the operation component 17 is operated when the user designates one of the plurality of HDMI input terminals 14a. In other words, the operation component 17 functions as a designating component. The operation component 17 is configured to designate one of the HDMI input terminals 14a as a designated HDMI input terminal.

The operation component 17 is configured to designate one of the plurality of HDMI input terminals 14a in a specific order. Specifically, the operation component 17 is configured to select one of the plurality of HDMI input terminals 14a to switch inputs inputted via the plurality of HDMI input terminals 14a. Every time the user presses an “HDMI” key provided to the operation component 17, the HDMI input terminals 14a are designated in the order of “first HDMI input terminal 14a1”→“second HDMI input terminal 14a2”→“third HDMI input terminal 14a3”→“default” to switch inputs. The “default” here is designated when none of the plurality of HDMI input terminals 14a is designated. In other words, the “default” is designated when the tuner 11 is designated.

As shown in FIG. 1, the control unit 18 includes a CPU (Central Processing Unit) 181, a RAM (Random Access Memory) 182, a memory component 183, etc.

The CPU 181 performs various control operations according to various kinds of processing program used for the television receiver 1 and stored in the memory component 183.

The RAM 182 includes a program storage region and a data storage region. The program storage region temporally stores processing programs executed by the CPU 181. The data storage region stores input data and the processing results produced in the execution of the processing programs.

The memory component 183 stores a system program that can be executed by the television receiver 1, various processing programs that can be executed by the system program, data used in the execution of the various processing programs, data for the processing results obtained in computations by the CPU 181, etc. The programs are stored in the memory component 183 in the form of program code that can be read by a computer. More specifically, the memory component 183 stores a switching control program 183a.

The switching control program 183a controls the power switching component 14b. Then, the switching control program 183a causes the CPU 181 to execute a function of switching the plurality of HDMI input terminals 14a between the power-on state and the power-off state.

More specifically, when one of the HDMI input terminals 14a is designated by operation of the operation component 17 by the user, the CPU 181 inputs a control signal to the power switching component 14b, and switches the designated HDMI input terminal 14a to the power-on state.

More specifically, when the “HDMI” key on the operation component 17 is pressed, the CPU 181 decides that the first HDMI input terminal 14a1 has been designated. Then, the CPU 181 switches on the hot plug of the first HDMI input terminal 14a1. Next, when the “HDMI” key on the operation component 17 is pressed again, the CPU 181 decides that the second HDMI input terminal 14a2 has been designated. Then, the CPU 181 switches off the hot plug of the first HDMI input terminal 14a1, and switches on the hot plug of the second HDMI input terminal 14a2. Next, when the “HDMI” key on the operation component 17 is pressed again, the CPU 181 decides that the third HDMI input terminal 14a3 has been designated. Then, the CPU 181 switches off the hot plug of the second HDMI input terminal 14a2, and switches on the hot plug of the third HDMI input terminal 14a3. Next, when the “HDMI” key on the operation component 17 is pressed again, the CPU 181 decides that “default” has been designated. In other words, the CPU 181 decides that none of the HDMI input terminals 14a has been designated. Then, the CPU 181 switches off the hot plug of the third HDMI input terminal 14a3. The CPU 181 repeatedly performs the series of operations.

The power switching component 14b and the CPU 181 that has executed the switching control program 183a function as a switching component.

### Power Switching Processing

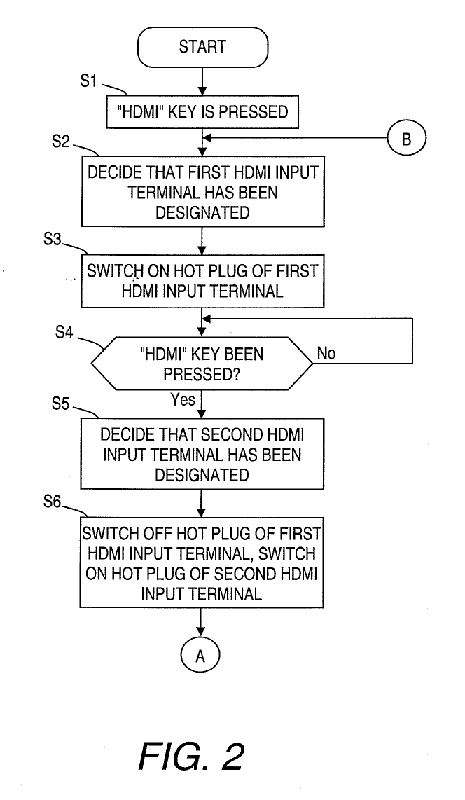

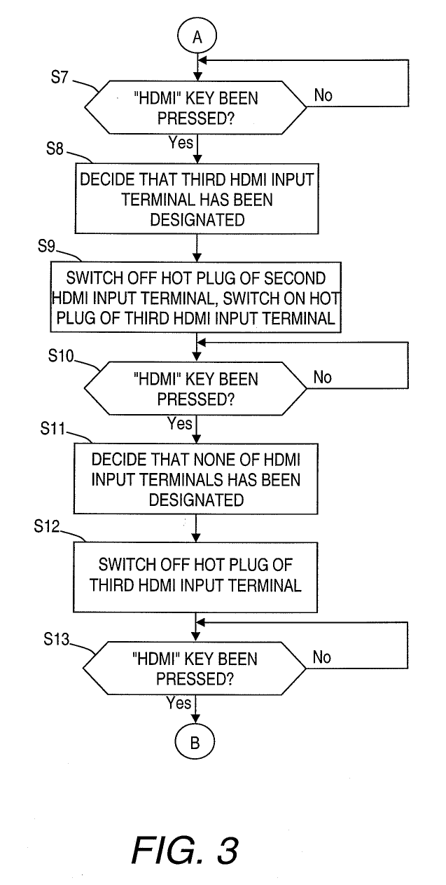

Next, processing related to power switching of the HDMI input terminals 14a in the television receiver 1 will be described through reference FIGS. 2 and 3.

First, when the user presses the “HDMI” key by operating the operation component 17 (step S1), the CPU 181 decides that the first HDMI input terminal 14a1 has been designated out of the plurality of HDMI input terminals 14a (step S2). The CPU 181 executes the switching control program 183a to input a control signal to the power switching component 14b. Then, the CPU 181 switches on the hot plug of the first HDMI input terminal 14a1 (step S3). As a result, when the first HDMI input terminal 14a1 is connected to the DVD player 3, the television receiver 1 executes the authentication processing with the DVD player 3 via the first HDMI input terminal 14a1 and receives the HDMI digital signal sent by the DVD player 3.

Next, the CPU 181 decides whether or not the user has pressed the “HDMI” key again by operating the operation component 17 (step S4).

If the CPU 181 decides in step S4 that the “HDMI” key has not been pressed again (step S4; No), then the CPU 181 repeats the processing of step S4.

On the other hand, if the CPU 181 decides in step S4 that the “HDMI” key has been pressed again (step S4; Yes), then the CPU 181 decides that the second HDMI input terminal 14a2 has been designated out of the plurality of HDMI input terminals 14a (step S5). The CPU 181 executes the switching control program 183a to input a control signal to the power switching component 14b. Then, the CPU 181 switches off the hot plug of the first HDMI input terminal 14a1, and switches on the hot plug of the second HDMI input terminal 14a2 (step S6). As a result, the television receiver 1 executes the authentication processing with the DVD player 3 via the second HDMI input terminal 14a2 and receives the HDMI digital signal sent by the DVD player 3.

Next, the CPU 181 decides whether or not the user has pressed the “HDMI” key again by operating the operation component 17 (step S7).

If the CPU 181 decides in step S7 that the “HDMI” key has not been pressed again (step S7; No), then the CPU 181 repeats the processing of step S7.

On the other hand, if the CPU 181 decides in step S7 that the “HDMI” key has been pressed again (step S7; Yes), then the CPU 181 decides that the third HDMI input terminal 14a3 has been designated out of the plurality of HDMI input terminals 14a (step S8). The CPU 181 executes the switching control program 183a to input a control signal to the power switching component 14b. Then, the CPU 181 switches off the hot plug of the second HDMI input terminal 14a2, and switches on the hot plug of the third HDMI input terminal 14a3 (step S9). As a result, when the third HDMI input terminal 14a3 is connected to the DVD player 3, the television receiver 1 executes the authentication processing with the DVD player 3 via the third HDMI input terminal 14a3 and receives the HDMI digital signal sent by the DVD player 3.

Next, the CPU 181 decides whether or not the user has pressed the “HDMI” key again by operating the operation component 17 (step S10).

If the CPU 181 decides in step S10 that the “HDMI” key has not been pressed again (step S10; No), then the CPU 181 repeats the processing of step S10.

On the other hand, if the CPU 181 decides in step S10 that the “HDMI” key has been pressed again (step S10; Yes), then the CPU 181 decides that the “default” has been designated. In other words, the CPU 181 decides that none of the plurality of HDMI input terminals 14a has been designated (step S11). The CPU 181 executes the switching control program 183a to input a control signal to the power switching component 14b. Then, the CPU 181 switches off the hot plug of the third HDMI input terminal 14a3 (step S12).

Next, the CPU 181 decides whether or not the user has pressed the “HDMI” key again by operating the operation component 17 (step S13).

If the CPU 181 decides in step S13 that the “HDMI” key has not been pressed again (step S13; No), then the CPU 181 repeats the processing of step S13.

On the other hand, if the CPU 181 decides in step S10 that the “HDMI” key has been pressed again (step S13; Yes), then the CPU 181 repeats the processing from step S2.

The television receiver 1 is connected to the DVD player 3. The DVD player 3 sends the HDMI digital signals in the HDMI (High-Definition Multimedia Interface) standard. The television receiver 1 receives the HDMI digital signals sent by the DVD player 3. The television receiver 1 includes the plurality of HDMI input terminals 14a, the power switching component 14b, the CPU 181 and the operation component 17. The plurality of HDMI input terminals 14a receives the HDMI digital signals. The power switching component 14b switches the plurality of HDMI input terminals 14a between the power-on state and the power-off state. The power-on state is a state in which the hot plug is enabled or switched on. The power-off state is a state in which the hot plug is disabled or switched off. The CPU 181 executes the switching control program 183a. The operation component 17 is operated by the user to designate one of the plurality of HDMI input terminals 14a. When the user designates one of the HDMI input terminals 14a by operation of the operation component 17, the designated input terminal 14a is switched to the power-on state. Specifically, the hot plug of the designated HDMI input terminal 14a is enabled (e.g., switched on) by the power switching component 14b and the CPU 181 that has executed the switching control program 183a. Thus, even though the plurality of HDMI input terminals 14a are provided, only the hot plug of the designated HDMI input terminal 14a designated by the user is enabled (e.g., switched on). Therefore, power consumption is reduced.

### Second Embodiment

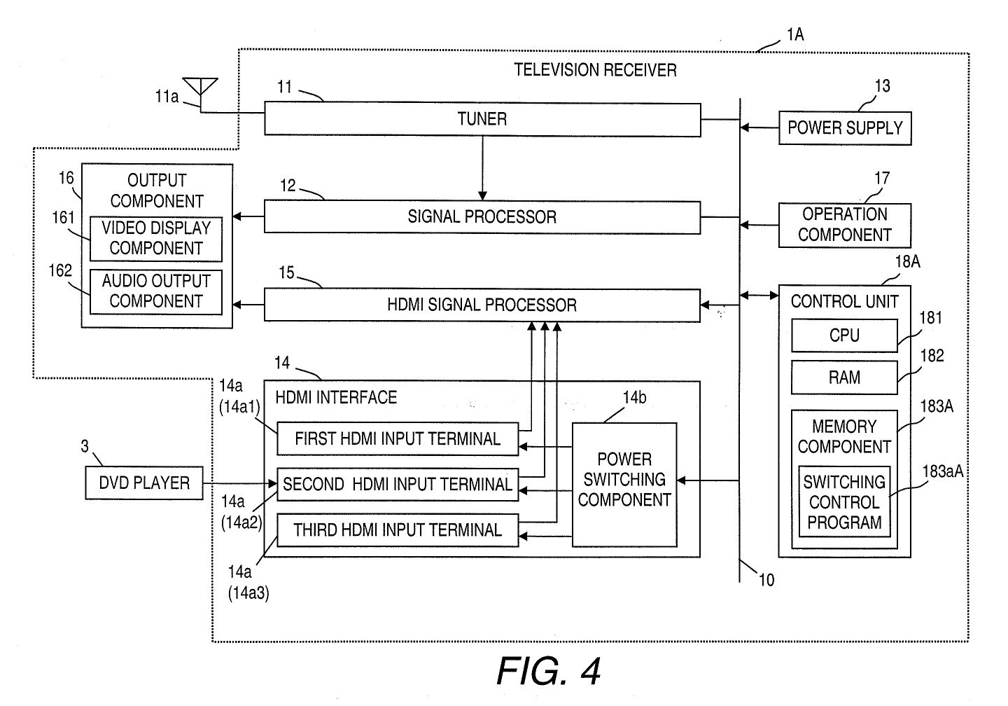

Referring now to FIGS. 4 to 6, a television receiver 1A in accordance with a second embodiment will now be explained. In view of the similarity between the first and second embodiments, the parts of the second embodiment that are identical to the parts of the first embodiment will be given the same reference numerals as the parts of the first embodiment. Moreover, the descriptions of the parts of the second embodiment that are identical to the parts of the first embodiment may be omitted for the sake of brevity.

### Configuration of Television Receiver

First, a configuration of the television receiver (e.g., receiving apparatus) 1A will be described. The television receiver 1A of the second embodiment differs from the television receiver 1 of the first embodiment only in the way that the power is switched on and off to the HDMI input terminals 14a. More specifically, part of the configuration of the control unit 18 of the television receiver 1 (FIG. 1) is different.

As shown in FIG. 4, a control unit 18A includes the CPU 181, the RAM 182, a memory component 183A, etc.

The memory component 183A stores a system program that can be executed by the television receiver 1A, various processing programs that can be executed by the system program, data used in the execution of these various processing programs, data for the processing results obtained in computations by the CPU 181, etc. The programs are stored in the memory component 183A in the form of program code that can be read by a computer. More specifically, the memory component 183A stores a switching control program 183aA.

The switching control program 183aA controls the power switching component 14b, and causes the CPU 181 to execute a function of switching the three or more HDMI input terminals 14a between the power-on state and the power-off state. The power-on state is a state in which the hot plug is enabled (e.g., switched on). The power-off state is a state in which the hot plug is disabled (e.g., switched off).

Specifically, when one of the HDMI input terminals 14a is designated by operation of the operation component 17 by the user, the CPU 181 inputs a control signal to the power switching component 14b. Specifically, the operation component 17 is configured to designate one of the plurality of HDMI input terminals 14a in a specific order. Thus, the CPU 181 switches the designated HDMI input terminal 14a and a next designated HDMI input terminal 14a. Here, the next designated HDMI input terminal 14a is a HDMI input terminal that is set to be designated next to the designated HDMI input terminal 14a in the specific order.

When the power is turned on to the television receiver 1A, the CPU 181 switches on the hot plug of the first HDMI input terminal 14a1.

Next, when the “HDMI” key on the operation component 17 is pressed, the CPU 181 decides that the first HDMI input terminal 14a1 has been designated. Then, the CPU 181 switches on the hot plug of the second HDMI input terminal 14a2, which is the next designated HDMI input terminal designated next to the first HDMI input terminal 14a1. Specifically, in this case, the hot plugs of the first HDMI input terminal 14a1 and the second HDMI input terminal 14a2 are on. Next, when the “HDMI” key on the operation component 17 is pressed again, the CPU 181 decides that the third HDMI input terminal 14a3 has been designated. Then, the CPU 181 switches off the hot plug of the second HDMI input terminal 14a2. Specifically, in this case, the hot plug of the third HDMI input terminal 14a3 is on. Next, when the “HDMI” key on the operation component 17 is pressed again, the CPU 181 decides that “default” has been designated. In other words, the CPU 181 decides that none of the HDMI input terminals 14a has been designated. Then, the CPU 181 switches off the hot plug of the third HDMI input terminal 14a3, and also switches on the hot plug of the first HDMI input terminal 14a1, which is the next designated terminal after “default”. Specifically, in this case, the hot plug of the first HDMI input terminal 14a1 is on. The CPU 181 repeatedly performs the series of operations.

The power switching component 14b and the CPU 181 that has executed the switching control program 183aA function as a switching component.

### Power Switching Processing

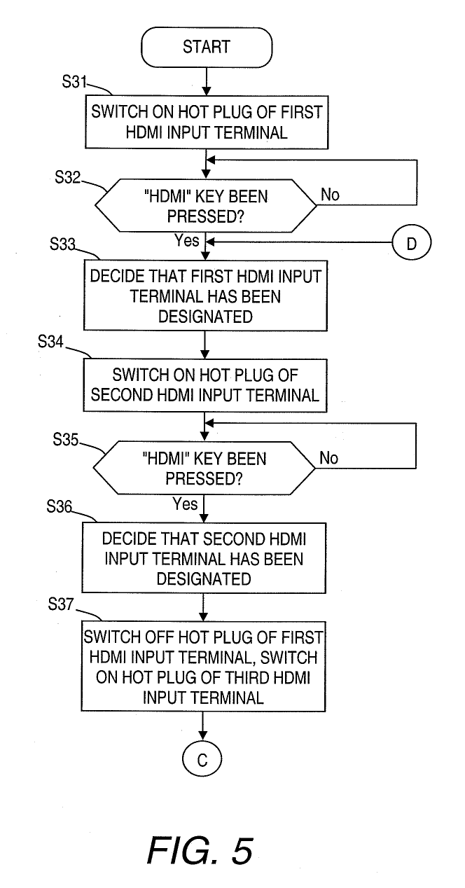

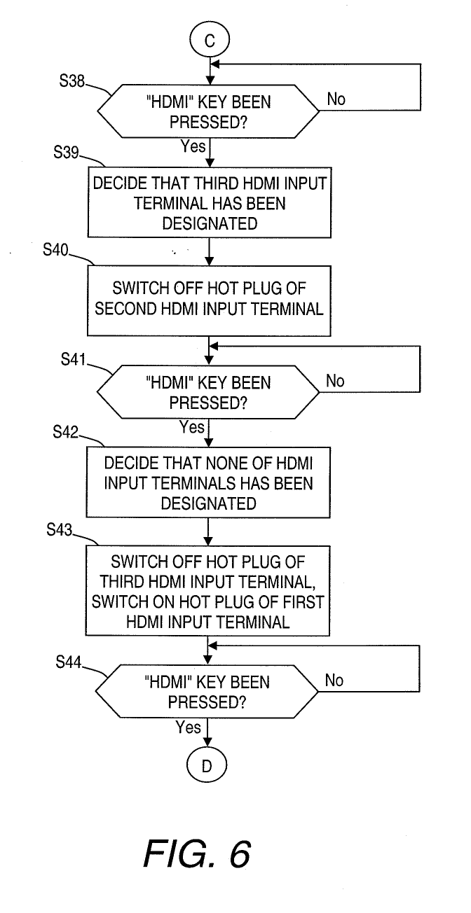

Next, processing related to power switching of the HDMI input terminals 14a in the television receiver 1A will be described through reference to FIGS. 5 and 6.

When the power is turned on to the television receiver 1A, the CPU 181 executes the switching control program 183aA to input a control signal to the power switching component 14b. Then, the CPU 181 switches on the hot plug of the first HDMI input terminal 14a1 (step S31).

Next, the CPU 181 decides whether or not the user has pressed the “HDMI” key by operating the operation component 17 (step S32).

If the CPU 181 decides in step S32 that the “HDMI” key has not been pressed (step S32; No), then the CPU 181 repeats the processing of step S32.

On the other hand, if the CPU 181 decides in step S32 that the “HDMI” key has been pressed (step S32; Yes), then the CPU 181 decides that the first HDMI input terminal 14a1 has been designated out of the HDMI input terminals 14a (step S33). The CPU 181 executes the switching control program 183aA to input a control signal to the power switching component 14b. Then, the CPU 181 switches on the hot plug of the second HDMI input terminal 14a2 (step S34).

Next, the CPU 181 decides whether or not the user has pressed the “HDMI” key again by operating the operation component 17 (step S35).

If the CPU 181 decides in step S35 that the “HDMI” key has not been pressed again (step S35; No), then the CPU 181 repeats the processing of step S35.

On the other hand, if the CPU 181 decides in step S35 that the “HDMI” key has been pressed again (step S35; Yes), then the CPU 181 decides that the second HDMI input terminal 14a2 has been designated out of the HDMI input terminals 14a (step S36). The CPU 181 executes the switching control program 183aA to input a control signal to the power switching component 14b. Then, the CPU 181 switches off the hot plug of the first HDMI input terminal 14a1, and switches on the hot plug of the third HDMI input terminal 14a3 (step S37).

Next, the CPU 181 decides whether or not the user has pressed the “HDMI” key again by operating the operation component 17 (step S38).

If the CPU 181 decides in step S38 that the “HDMI” key has not been pressed again (step S38; No), then the CPU 181 repeats the processing of step S38.

On the other hand, if the CPU 181 decides in step S38 that the “HDMI” key has been pressed again (step S38; Yes), then the CPU 181 decides that the third HDMI input terminal 14a3 has been designated out of the HDMI input terminals 14a (step S39). The CPU 181 executes the switching control program 183aA to input a control signal to the power switching component 14b. Then, the CPU 181 switches off the hot plug of the second HDMI input terminal 14a2 (step S40).

Next, the CPU 181 decides whether or not the user has pressed the “HDMI” key again by operating the operation component 17 (step S41).

If the CPU 181 decides in step S41 that the “HDMI” key has not been pressed again (step S41; No), then the CPU 181 repeats the processing of step S41.

On the other hand, if the CPU 181 decides in step S41 that the “HDMI” key has been pressed again (step S41; Yes), then the CPU 181 decides that the “default” has been designated. In other words, the CPU 181 decides that none of the HDMI input terminals 14a has been designated (step S42). The CPU 181 executes the switching control program 183aA to input a control signal to the power switching component 14b. Then, the CPU 181 switches off the hot plug of the third HDMI input terminal 14a3, and switches on the hot plug of the first HDMI input terminal 14a1 (step S43).

Next, the CPU 181 decides whether or not the user has pressed the “HDMI” key again by operating the operation component 17 (step S44).

If the CPU 181 decides in step S44 that the “HDMI” key has not been pressed again (step S44; No), then the CPU 181 repeats the processing of step S44.

On the other hand, if the CPU 181 decides in step S44 that the “HDMI” key has been pressed again (step S44; Yes), then the CPU 181 repeats the processing from step S33.

With the television receiver 1A, when the user designates one of the HDMI input terminals 14a by operation of the operation component 17, the designated HDMI input terminal 14a and the next designated HDMI input terminal 14a designated next to the designated HDMI input terminal 14a is switched to the power-on state (a state in which the hot plug is switched on) by the power switching component 14b and the CPU 181 that has executed the switching control program 183aA. Specifically, even though three or more of the HDMI input terminals 14a are provided, only the hot plugs of the HDMI input terminal 14a designated by the user and the next designated HDMI input terminal 14a designated next to the designated HDMI input terminal 14a are switched on. Therefore, power consumption is reduced.

Also, when one of the HDMI input terminals 14a has been designated by the user, the hot plug is switched on not just for the designated HDMI input terminal, but also for the next designated HDMI input terminal 14a designated next to the designated HDMI input terminal 14a. Thus, when the user designates the next designated HDMI input terminal 14a, the hot plug at the next designated HDMI input terminal is already be on. Therefore, response to the designation of an HDMI input terminal 14a by the user is faster. As a result, this makes the device more convenient to use.

The present invention is not limited to the embodiments described above, and various modifications can be made as needed without departing from the scope of the invention.

The television receiver 1 and 1A of the first and second embodiments can be any receiving apparatus capable of receiving the HDMI digital signals sent by a sending apparatus. Also, the DVD player 3 of the first and second embodiments can be any sending apparatus capable of sending the HDMI digital signals to a receiving apparatus.

The operation component 17 of the first embodiment can include a “first HDMI” key, a “second HDMI” key, a “third HDMI” key, a “default” key, etc. Then, one of a plurality of HDMI input terminals 14a can be designated in an arbitrary order by pressing one of the first HDMI key, the second HDMI key, the third HDMI key and the default key.

The number of the HDMI input terminals 14a can be determined as desired, so long as a plurality of HDMI input terminals 14a can be provided to the television receiver 1 in the first embodiment, and three or more HDMI input terminals 14a are provided to the television receiver 1A in the second embodiment.

In the second embodiment, when the user designated one of the HDMI input terminals 14a by operating the operation component 17, the designated HDMI input terminal 14a and the next designated HDMI input terminal 14a designated next to the designated HDMI input terminal 14a are switched to the power-on state (a state in which the hot plug is switched on). However, when the user makes no designation of an HDMI input terminal 14a by operating the operation component 17 within a specific period of time, the next designated HDMI input terminal 14a can be switched from the power-on state to the power-off state.

### GENERAL INTERPRETATION OF TERMS

In understanding the scope of the present invention, the term “configured” as used herein to describe a component, section or part of a device includes hardware and/or software that is constructed and/or programmed to carry out the desired function. In understanding the scope of the present invention, the term “comprising” and its derivatives, as used herein, are intended to be open ended terms that specify the presence of the stated features, elements, components, groups, integers, and/or steps, but do not exclude the presence of other unstated features, elements, components, groups, integers and/or steps. The foregoing also applies to words having similar meanings such as the terms, “including”, “having” and their derivatives. Also, the terms “part,” “section,” “portion,” “member” or “element” when used in the singular can have the dual meaning of a single part or a plurality of parts.

While only selected embodiments have been chosen to illustrate the present invention, it will be apparent to those skilled in the art from these disclosure that various changes and modifications can be made herein without departing from the scope of the invention as defined in the appended claims. Furthermore, the foregoing descriptions of the selected embodiments according to the present invention are provided for illustration only, and not for the purpose of limiting the invention as defined by the appended claims and their equivalents.

What is claimed is:

1. A receiving apparatus for receiving digital signals in a HDMI standard, comprising:
a plurality of HDMI input terminals configured to receive the digital signals in the HDMI standard;
a designating component configured to designate one of the HDMI input terminals as a designated HDMI input terminal; and
a switching component configured to switch the HDMI input terminals between a power-on state and a power-off state in response to designating the designated HDMI input terminal.

2. The receiving apparatus according to claim 1, wherein
the switching component is further configured to switch the designated HDMI input terminal to the power-on state when the designating component designates the designated HDMI input terminal.

3. The receiving apparatus according to claim 2, wherein
the switching component is further configured to switch the designated HDMI input terminal to the power-off state when the designating component newly designates one of the HDMI input terminals other than the designated HDMI input terminal.

4. The receiving apparatus according to claim 1, wherein
the designating component is further configured to designate one of the HDMI input terminals in a specific order, and
the switching component is further configured to switch the designated HDMI input terminal and a next designated HDMI input terminal that is set to be designated next to the designated HDMI input terminal in the specific order to the power-on state when the designating component designates the designated HDMI input terminal.

5. The receiving apparatus according to claim 4, wherein
the HDMI input terminals include at least three.

6. The receiving apparatus according to claim 5, wherein
the switching component is further configured to switch the designated HDMI input terminal to the power-off state when the designating component newly designates one of the HDMI input terminals other than the designated HDMI input terminal and the next designated HDMI input terminal.

7. A receiving apparatus for receiving digital signals in a HDMI standard, comprising:
a plurality of HDMI input terminals configured to receive the digital signals in the HDMI standard;
a designating component configured to designate one of the HDMI input terminals as a designated HDMI input terminal; and
a switching component configured to switch the HDMI input terminals between an enable state in which a hot plug is enabled and a disable state in which the hot plug is disabled in response to designating the designated HDMI input terminal.

8. The receiving apparatus according to claim 7, wherein
the switching component is further configured to switch the designated HDMI input terminal to the enable state when the designating component designates the designated HDMI input terminal.

9. The receiving apparatus according to claim 8, wherein
the switching component is further configured to switch the designated HDMI input terminal to the disable state when the designating component newly designates one of the HDMI input terminals other than the designated HDMI input terminal.

10. The receiving apparatus according to claim 7, wherein
the designating component is further configured to designate one of the HDMI input terminals in a specific order, and
the switching component is further configured to switch the designated HDMI input terminal and a next designated HDMI input terminal that is set to be designated next to the designated HDMI input terminal in the specific order to the enable state when the designating component designates the designated HDMI input terminal.

11. The receiving apparatus according to claim 10, wherein
the HDMI input terminals include at least three.

12. The receiving apparatus according to claim 11, wherein
the switching component is further configured to switch the designated HDMI input terminal to the disable state when the designating component newly designates one of the HDMI input terminals other than the designated HDMI input terminal and the next designated HDMI input terminal.

13. A receiving method for a receiving apparatus for receiving digital signals in a HDMI standard, comprising:
designating one of a plurality of HDMI input terminals as a designated HDMI input terminal; and
switching the HDMI input terminals between a power-on state and a power-off state in response to designating the designated HDMI input terminal.
